(19) United States
(12) Patent Application Publication
(10) Pub. No.: US 2018/0259816 A1
(43) Pub. Date: Sep. 13, 2018

(54) LIQUID CRYSTAL DISPLAY PANEL, MANUFACTURING METHOD THEREOF, AND APPLIED DISPLAY APPARATUS THEREOF

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/561,700

(22) PCT Filed: Jul. 7, 2017
(86) PCT No.: PCT/CN2017/092165

§ 371 Date: Sep. 26, 2017

(30) Foreign Application Priority Data
Mar. 10, 2017 (CN) 201710142018.9

(51) Int. Cl. G02F 1/1362; G02F 1/1368; G02F 1/1339

(52) U.S. Cl. CPC G02F 1/136209; G02F 1/1368; G02F 1/133528; G02F 1/1339; G02F 1/136286

(57) ABSTRACT

The invention relates to a liquid crystal display panel, manufacturing method thereof, and application display apparatus thereof. The method of manufacturing the liquid crystal display panel comprises: providing a transparent substrate and an active switch array substrate; forming a light-shading layer on a peripheral region of an inner surface of the active switch array substrate, wherein the light-shading layer is a material with low reflectivity; forming an active switch array inside the active switch array substrate; and forming a liquid crystal layer between the transparent substrate and the active switch array substrate.

### BACKGROUND OF THE INVENTION

### Field of Invention

The present invention generally relates to a liquid crystal display panel, manufacturing method thereof, and applied display apparatus thereof. Especially, the present invention relates to a no-bezel type liquid crystal display panel, manufacturing method thereof, and applied display apparatus thereof.

### Description of Related Art

In recent years, with the progress of science and technology, a variety of display devices, such as a liquid crystal display (LCD) or an electroluminescence (EL) display, is widely used in a flat panel display field. Taking a liquid crystal display (LCD) as an example, a backlight type LCD display is a major type LCD display substantially composed of a liquid crystal display panel and a backlight module. The liquid crystal display panel includes two transparent substrates and a plurality of liquid crystals encapsulated between the two transparent substrates.

A liquid crystal display (LCD) is gradually developed into a new no-bezel type design for more emphasizing a whole clear image with overall viewing user experience. The no-bezel design is a kind of liquid crystal display (LCD) without bezel around a display panel, resulting in a problem of serious side light leakage (unwanted bright dots or bright crevices). The problem of side light leakage should be resolved or overcome while there is no bezel disposed around the display panel. In addition, when the display panel arrays of the no-bezel liquid crystal display (LCD) devices show upward, metals around the display panel will reflect a light from the display panel to downgrade a visual effect and influence a visual quality of the liquid crystal display (LCD) products.

### SUMMARY OF THE INVENTION

For resolving the technical problems above-mentioned, the objects of the present invention are to develop a new liquid crystal display panel, manufacturing method thereof, and application display apparatus thereof, so that the light reflected on the metal around the display panel can be reduced.

The objects and technical solutions of the present invention are implemented by following technical ways and means. In one perspective, the present invention provides a liquid crystal display panel, comprising: a transparent substrate; an active switch array substrate disposed oppositely to the transparent substrate, wherein the active switch array substrate comprises an active switch array, and the active switch array is formed inside the active switch array substrate; a liquid crystal layer disposed between the transparent substrate and the active switch array substrate; and a light-shading layer disposed on a peripheral region of an inner surface of the active switch array substrate, wherein the light-shading layer includes a material with low reflectivity; wherein the transparent substrate faces to a backlight module, and the active switch array substrate faces to a user.

In one embodiment of the present invention, the light-shading layer is disposed on a peripheral region of the active switch array.

In some embodiments of the present invention, the active switch array substrate includes peripheral metal wirings. The peripheral metal wirings are formed on the peripheral region of the active switch array. The light-shading layer is disposed on outside region of the active switch array and covers the peripheral metal wirings.

In some embodiment of the present invention, the frame sealing glue is disposed between the active switch array substrate and the transparent substrate, and disposed outside of the active switch array and the liquid crystal layer, wherein the light-shading layer is disposed on an inner surface of the active switch array substrate and adjacent to the frame sealing glue.

In some embodiments of the present invention, the light-shading layer is selected from a group substantially composed of a chromium oxide (CrOx) or the chromium oxide's mixture.

In some embodiments of the present invention, the light-shading layer is selected from a group substantially composed of a chromium nitride (CrNx) or the chromium nitride's mixture.

The present invention provides a manufacturing method of a liquid crystal display, comprising:

Providing a transparent substrate and an active switch array substrate;

Forming a light-shading layer on a peripheral region of an inner surface of the active switch array substrate, wherein the light-shading layer includes a material with low reflectivity;

Forming an active switch array inside the active switch array substrate; and

Forming a liquid crystal layer between the transparent substrate and the active switch array substrate;

In some embodiments of the present invention, the active switch array substrate includes peripheral metal wirings. The peripheral metal wirings are formed on the peripheral region of the active switch array. The light-shading layer is disposed on outside region of the active switch array and covers the peripheral metal wirings.

In some embodiments of the present invention, the light-shading layer is selected from a group substantially composed of a chromium nitride, a chromium oxide, the chromium nitride's mixture, the chromium oxide's mixture or a combination thereof.

The present invention further provides a liquid crystal display apparatus, comprising: a backlight module; a backlight module; a transparent substrate; an active switch array substrate disposed oppositely to the transparent substrate, wherein the active switch array substrate comprises an active switch array, the active switch array is formed inside the active switch array substrate; a liquid crystal layer disposed between the transparent substrate and the active switch array substrate; a frame sealing glue disposed between the active switch array substrate and the transparent substrate, and disposed outside of the active switch array and the liquid crystal layer; a light-shading layer selected from a group substantially composed of a chromium nitride, a chromium oxide, the chromium nitride's mixture, the chromium oxide's mixture or a combination thereof, the light-shading layer disposed on a peripheral region of an inner surface of the active switch array substrate and adjacent to the frame sealing glue, and the light-shading layer adjacent to the active switch array and covers a peripheral region of the active switch array; wherein the transparent substrate faces to a backlight module, and the active switch array substrate faces to a user.

The advantage of the present invention is that it can absorb and shade a light reflected from the peripheral metal wirings of the active switch array substrate, and it can reduce bad visual effect resulted from reflection on the peripheral metal wirings. And, comparing with current method of manufacturing a no-bezel type array substrate, the present invention adds a process of forming a light-shading layer using a low reflectivity material based on a chromium oxide (CrOx) or a chromium nitride (CrNx) before 4 or 5 processes of current method of forming an active switch array. The light-shading layer is used for replacing a peripheral black bezel on the back of a no-bezel type active switch array substrate. Since the black matrix (BM) is not formed outside of the glass substrate, a scratching problem can be reduced when overturning the display panel and a yield rate of manufacturing a display panel can be increased.

### BRIEF DESCRIPTION OF THE DRAWINGS

FIG. 1 shows a traditional example structure of a backlight module of a liquid crystal display (LCD).

FIG. 1a shows a cross-sectional view illustrating a panel array layer according to one embodiment of the present invention.

FIG. 1b shows a cross-sectional view illustrating a panel array layer with a material with a light-shading ability and low reflectivity disposed on an active switch array substrate according to one embodiment of the present invention.

FIGS. 2a to 2c show a cross-sectional view illustrating forming an active switch array substrate on a light-shading layer according to another embodiment of the present invention.

### DESCRIPTION OF THE PREFERRED EMBODIMENTS

The drawings as referred to throughout the description of the present invention are examples for implementing the objects of the present invention. The orientation words or terms used in the description of the present invention, such as “above”, “under”, “forward”, “backward”, “left”, “right”, “inner”, “outer”, “side”, etc. are examples in the drawings for illustrative purpose only, or just show the interrelations between the components, but not to be construed as limitations to the scope of the present invention.

The drawings and the description of the present invention are deemed to be examples but not limitations essentially. In the drawings, components or elements having similar or same structure are marked with the same numbers. In addition, sizes and thicknesses of every component or element are just examples, but not drawn according to actual scale and not read as limitations to the scope of the present invention.

In drawings of the present invention, sizes and thicknesses of layers, films, panels, or regions are emphasized for clearness, easy to describe and easy to understand. Therefore, some layers, films, or regions are emphasized but not drawn according to their actual scales. It is to be understood that, for example, when one of the components of layers, films, regions, or substrate are “on” another component of layers, films, regions, or substrate, the one of the components of layers, films, regions, or substrate could be adjacent on another component of layers, films, regions, or substrate directly, or there could be other inter-components of layers, films, regions, or substrate disposed therebetween.

Furthermore, in the description of the present invention, a word “comprising” or “including” is construed to comprise or include the related components but not exclude other components, except there is clearly opposite word or description in the present invention. And, in the description of the present invention, a word “on” is construed to be above or under a target component, but not construed to be on a top of the target component in vertical or gravity direction.

For further clarifying the technical solutions or functions of the present invention to implement the objects of the present invention, a liquid crystal display panel, manufacturing method thereof, and application display apparatus, and their specific implementations, structures, features and functions, according to a preferred embodiment of the present invention will be apparent from the following detailed description, which proceeds with reference to the accompanying drawings.

A liquid crystal display (LCD) includes liquid crystals disposed between two glass substrates applied with an electric field, so that an image or numbers can be shown. The liquid crystals are substantially composed of a kind of material between liquid and solid. The liquid crystal display (LCD) needs a backlight module for providing light, because the liquid crystal display (LCD) cannot emit light by itself. An image can be shown by controlling the light passing through the liquid crystal display (LCD) panel, wherein liquid crystals are disposed within the liquid crystal display (LCD) uniformly.

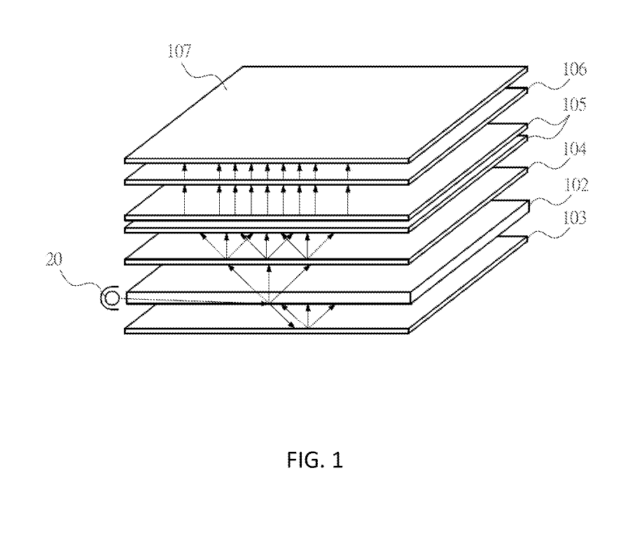

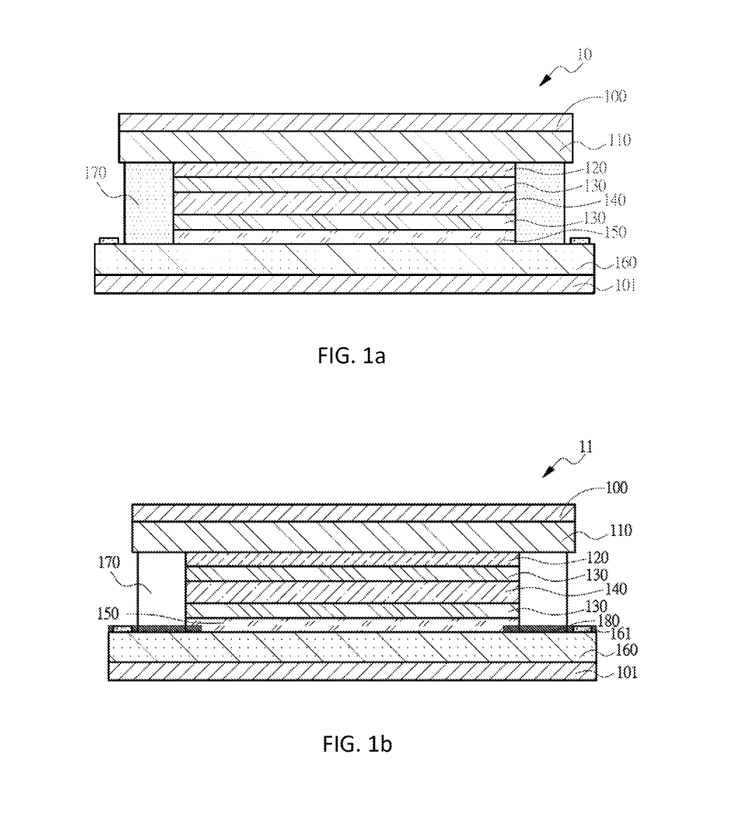

FIG. 1 shows a traditional backlight module of a liquid crystal display (LCD). As shown in FIG. 1, a backlight module of a liquid crystal display (LCD) comprises: a light source 20, a light-guiding plate 102, a reflective plate 103, a diffuser plate 104, a prism sheet 105, and a protection plate 106. First, the light source 20 is used for emitting light into the liquid crystal display (LCD). Currently, there are a variety of light sources could be used in the liquid crystal display (LCD). The light-guiding plate 102 is disposed under a liquid crystal display panel 107, and the light source 20 is near one side of the light-guiding plate 102. The light-guiding plate 102 is used for transforming a light from a point light source into a surface-scattering light, and the surface-scattering light is then projected on the liquid crystal display panel 107.

The reflective plate 103 is disposed under the light-guiding plate 102. The reflective plate 103 is used for reflecting the light emitted from the light source 20 to the liquid crystal display panel 107 located in front of the reflective plate 103. The diffuser plate 104 is disposed above the light-guiding plate 102 for evening the light distribution, wherein the light is reflected from the reflective plate 103 and passes through the light-guiding plate 102. When the light passes through the diffuser plate 104, the light is diffused in both horizontal direction and vertical direction. The brightness of the light is accordingly largely reduced. To resolve the problem above-mentioned, the prism sheet 105 is used for refracting and concentrating the light to improve the brightness. Generally speaking, two prism sheets 105 are used in the backlight module and arranged in a way of being perpendicular to each other.

The protection plate 106 is disposed above the prism sheet 105. In a situation of using two perpendicular prism sheets 105, the protection plate 106 can be used for avoiding scratching on the prism sheet 105 and avoiding a Moire effect or wave effect. To sum up, a backlight module of a traditional liquid crystal display (LCD) includes the components above-mentioned.

Generally speaking, when the prism sheet 105 is disposed normally, a plurality of prism pillar units are arranged on a transparent film in a regular way along the same direction. The prism sheet 105 is used for refracting the light passing through the light-guiding plate 102 and is diffused by the diffuser plate 104. Generally speaking, when the light transmits and is refracted through a smaller width, the light through regions of transmitting and being refracted is brighter. On the contrary, when the light transmits and is refracted through a larger width, the light through regions of transmitting and being refracted is dimmer.

In recent years, as a liquid crystal display (LCD) is gradually developed to a large sized LCD panel design, it is accordingly important to maintain a light exit density beyond a predetermined level. In addition, as a liquid crystal display (LCD) wants to emphasize or improve a whole image with an overall viewing sense, a new no-bezel type design is accordingly introduced. However, when there is no bezel disposed around the display panel, the problem of side light leakage appears which should be resolved or overcome. Otherwise, a peripheral light leakage effect will be seriously. Furthermore, when the display panel arrays of the no-bezel liquid crystal display (LCD) devices show or display upward, metals around the display panel will reflect a light from the display panel to downgrade a visual effect and influence a visual quality of the liquid crystal display (LCD) products. Therefore, it is a very important key how to let light exit uniformly and resolve the problem of peripheral light leakage (unwanted bright dots or bright crevices on the peripheral region).

A liquid crystal display of the present invention comprises a backlight module and a liquid crystal display panel. The liquid crystal display panel can include an active switch array (ex: TFT, thin film transistor) substrate, a color filter (CF) substrate, and a liquid crystal (LC) layer disposed between the active switch array and the color filter (CF) substrate.

In one embodiment of the present invention, the present liquid crystal display panel can be a curved surface type display panel, and the present liquid crystal display apparatus can also be a curved surface type liquid crystal display apparatus.

FIG. 1a shows a cross-sectional view illustrating a liquid crystal display (LCD) panel array layer 10 according to one embodiment of the present invention. FIG. 1b shows a cross-sectional view illustrating a panel array layer with a material with a light-shading ability and low reflectivity disposed on an active switch array substrate according to one embodiment of the present invention. Please refer to FIGS. 1a and 1b, in one embodiment of the present invention, the liquid crystal display panel 11 comprises: a transparent substrate 110 having an outer surface; a first polarizer 100 disposed on the outer surface of the transparent substrate 110; an active switch array substrate 160 disposed oppositely to the transparent substrate 110, the active switch array substrate 160 having an outer surface; a second polarizer 101 disposed on the outer surface of the active switch array substrate 160, the second polarizer 101 having an outer surface; a liquid crystal layer 140 disposed between the transparent substrate 110 and the active switch array substrate 160; and a light-shading layer 180 disposed on a peripheral region of an inner surface of the active switch array substrate 160, wherein the light-shading layer 180 includes a material with low reflectivity.

In one embodiment of the present invention, a light-spacer layer 130 is formed on a color filter patterned layer 120.

In one embodiment of the present invention, the method of forming the light-shading layer 180, the active switch array 150 and the color filter patterned layer 120 on a substrate includes: a photoresist coating process, an exposure process, a development process, and a mask process.

In one embodiment of the present invention, the light-shading layer 180 is disposed around and covers a peripheral region of the active switch array 150.

In one embodiment of the present invention, the light-shading layer 180 is disposed adjacent to an outside region of the active switch array 150.

In one embodiment of the present invention, the active switch array substrate 160 includes a peripheral metal wirings 161, wherein the peripheral metal wirings 161 is formed on the peripheral region of the active switch array 150, and the light-shading layer 180 is disposed on outside region of the active switch array 150 and covers the peripheral metal wirings 161.

In one embodiment of the present invention, the light-shading layer 180 is disposed on an inner surface of the active switch array substrate 160 and is adjacent to a frame sealing glue 170.

In one embodiment of the present invention, the light-shading layer 180 is disposed on an inner surface of the active switch array substrate 160 and between the active switch array substrate 160 and the frame sealing glue 170.

In one embodiment of the present invention, the light-shading layer 180 includes a material selected from a group substantially composed of a chromium oxide (CrOx) or the chromium oxide's mixture.

In one embodiment of the present invention, the light-shading layer 180 includes a material selected from a group substantially composed of a chromium nitride (CrNx) or the chromium nitride's mixture.

In one embodiment of the present invention, the transparent substrate 110 is a color filter (CF) substrate.

In one embodiment of the present invention, the active switch array substrate 160 is a thin film transistor (TFT) substrate.

Please refer to FIGS. 1a and 1b, in one embodiment of the present invention, the liquid crystal display panel 11 comprises: a backlight module and a liquid crystal display panel 11. The liquid crystal display panel 11 comprises: a transparent substrate 110 having an outer surface; a first polarizer 100 disposed on the outer surface of the transparent substrate 110; an active switch array substrate 160 disposed oppositely to the transparent substrate 110, the active switch array substrate 160 having an outer surface; a second polarizer 101 disposed on the outer surface of the active switch array substrate 160, the second polarizer 101 having an outer surface; a liquid crystal layer 140 disposed between the transparent substrate 110 and the active switch array substrate 160; a frame glue 170 disposed between a peripheral region of the transparent substrate 110 and a peripheral region of the active switch array substrate 160, and surrounding the liquid crystal layer 140; and a light-shading layer 180 disposed on a peripheral region of an inner surface of the active switch array substrate 160.

In one embodiment of the present invention, the light-shading layer 180 is disposed around and covers a peripheral region of the active switch array 150.

In one embodiment of the present invention, the light-shading layer 180 is disposed adjacent to an outside region of the active switch array 150.

In one embodiment of the present invention, the active switch array substrate 160 includes a peripheral metal wirings 161, wherein the peripheral metal wirings 161 is formed on the peripheral region of the active switch array 150, and the light-shading layer 180 is disposed on outside region of the active switch array 150 and covers the peripheral metal wirings 161.

In one embodiment of the present invention, the light-shading layer 180 disposed on an inner surface of the active switch array substrate 160 and adjacent to the frame sealing glue 170.

In one embodiment of the present invention, the light-shading layer 180 is disposed on an inner surface of the active switch array substrate 160 and is disposed between the active switch array substrate 160 and the frame sealing glue 170.

In one embodiment of the present invention, the light-shading layer 180 includes a material selected from a group substantially composed of a chromium oxide (CrOx) or the chromium oxide's mixture.

In one embodiment of the present invention, the light-shading layer 180 includes a material selected from a group substantially composed of a chromium nitride (CrNx) or the chromium nitride's mixture.

In one embodiment of the present invention, the transparent substrate 110 is a color filter substrate.

In one embodiment of the present invention, the active switch array substrate 160 is a thin film transistor (TFT) substrate.

In some embodiments of the present invention, a color filter (CF) and a thin film transistor can be formed on the same substrate.

Please refer to FIGS. 1a and 1b, the present invention further provide a manufacturing method of a liquid crystal display panel, comprising:

Providing a transparent substrate 110 and an active switch array substrate 160;

Forming a light-shading layer 180 on a peripheral region of an inner surface of the active switch array substrate 160, wherein the light-shading layer 180 includes a material with low reflectivity;

Forming an active switch array 150 inside the active switch array substrate 160;

Forming a liquid crystal layer 140 between the transparent substrate 110 and the active switch array substrate 160;

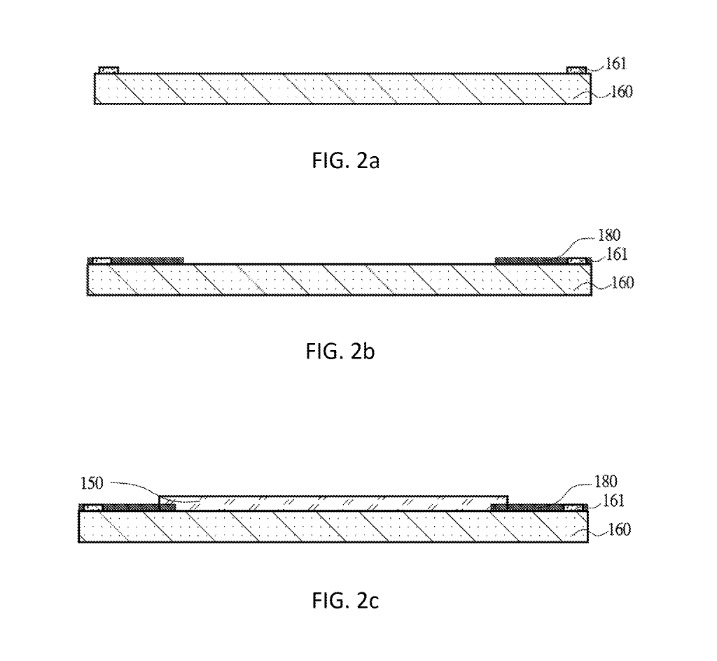

Please refer to FIGS. 2a to 2c, after the active switch array substrate 160 formed, and before 4 or 5 processes of traditional method of forming the active switch array 150, a process of forming a light-shading layer 180 is provided. In a meanwhile, the light-shading layer 180 is formed by a low reflectivity material based on a chromium oxide (CrOx) or a chromium nitride (CrNx). Therefore, the light-shading layer 180 of the present invention can absorb and shade a light reflected from the peripheral metal wirings of the active switch array substrate 160, and can reduce bad visual effect resulted from reflection from the peripheral metal wirings. Furthermore, the light-shading layer 180 of the present invention can replace a peripheral black bezel on the back of a no-bezel type active switch array substrate 160. Since the black matrix (BM) is not formed outside of the glass substrate, a scratching problem can be reduced when overturning the display panel and a yield rate of manufacturing a display panel can be increased.

“In some embodiments of the present invention” and “In a variety of embodiments of the present invention” are used repeatedly through the description. They usually mean different embodiments. However, they can also mean the same embodiments. “Comprising”, “having” and “including” are synonyms, except it is noted to be different or has other meaning before and after its description.

The present invention has been described in considerable detail with reference to certain preferred embodiments thereof. It should be understood that the description is for illustrative purpose, not for limiting the scope of the present invention. Those skilled in this art can readily conceive simple or equivalent variations and modifications, which are still within the spirit of the present invention.

What is claimed is:

1. A liquid crystal display panel, comprising:
a transparent substrate;
an active switch array substrate disposed oppositely to the transparent substrate, wherein the active switch array substrate comprises an active switch array, and the active switch array is formed inside the active switch array substrate;
a light-shading layer disposed on a peripheral region of an inner surface of the active switch array substrate, wherein the light-shading layer includes a material with low reflectivity; and
a liquid crystal layer formed between the transparent substrate and the active switch array substrate;
wherein the transparent substrate faces to a backlight module, and the active switch array substrate faces to a user.

2. The liquid crystal display panel according to claim 1, wherein the light-shading layer is disposed on a peripheral region of the active switch array.

3. The liquid crystal display panel according to claim 1, wherein the light-shading layer is disposed outside of the active switch array.

4. The liquid crystal display panel according to claim 1, wherein the active switch array substrate includes peripheral metal wirings, and the peripheral metal wirings are formed on a peripheral region of the active switch array, and the light-shading layer covers the peripheral metal wirings.

5. The liquid crystal display panel according to claim 1, wherein the light-shading layer is disposed on an inner surface of the active switch array substrate.

6. The liquid crystal display panel according to claim 1, further comprising: a frame sealing glue disposed between the active switch array substrate and the transparent substrate, and surrounding the liquid crystal layer, wherein the light-shading layer is disposed adjacent to the frame sealing glue.

7. The liquid crystal display panel according to claim 1, wherein the light-shading layer is a material selected from a group substantially composed of a chromium oxide (CrOx) or the chromium oxide's mixture.

8. The liquid crystal display panel according to claim 1, wherein the light-shading layer is a material selected from a group substantially composed of a chromium nitride (CrNx) or the chromium nitride's mixture.

9. A method of manufacturing a liquid crystal display panel, comprising:
providing a transparent substrate and an active switch array substrate;
forming a light-shading layer on a peripheral region of an inner surface of the active switch array substrate, wherein the light-shading layer includes a material with low reflectivity;
forming an active switch array inside the active switch array substrate; and
forming a liquid crystal layer between the transparent substrate and the active switch array substrate.

10. The method of manufacturing a liquid crystal display panel according to claim 9, wherein the light-shading layer is disposed outside of the active switch array.

11. The method of manufacturing a liquid crystal display panel according to claim 9, wherein the active switch array substrate includes peripheral metal wirings, the peripheral metal wirings is formed on a peripheral region of the active switch array, and the light-shading layer covers the peripheral metal wirings.

12. The liquid crystal display panel according to claim 9, wherein the light-shading layer is a material selected from a group substantially composed of a chromium oxide (CrOx) or the chromium oxide's mixture.

13. The liquid crystal display panel according to claim 9, wherein the light-shading layer is a material selected from a group substantially composed of a chromium nitride (CrNx) or the chromium nitride's mixture.

14. A liquid crystal display apparatus, comprising:
a backlight module;
a transparent substrate;
an active switch array substrate disposed oppositely to the transparent substrate, wherein the active switch array substrate comprises an active switch array, and the active switch array is formed inside the active switch array substrate;
a liquid crystal layer formed between the transparent substrate and the active switch array substrate;
a liquid crystal layer formed between the transparent substrate and the active switch array substrate;
a frame sealing glue disposed between the active switch array substrate and the transparent substrate, and disposed outside of the active switch array and the liquid crystal layer; and
a light-shading layer selected from a group substantially composed of a chromium nitride, a chromium oxide, the chromium nitride's mixture, the chromium oxide's mixture or a combination thereof, the light-shading layer disposed on a peripheral region of an inner surface of the active switch array substrate and adjacent to the frame sealing glue, and adjacent to the active switch array and covering a peripheral region of the active switch array;
wherein the transparent substrate faces to a backlight module, and the active switch array substrate faces to a user, the active switch array substrate is a no-bezel type active switch array substrate, and the light-shading layer is disposed on a peripheral region of an inner surface of the active switch array substrate for forming a peripheral black bezel.
